(19) United States
(12) Patent Application Publication
(10) Pub. No.: US 2018/0269522 A1
(43) Pub. Date: Sep. 20, 2018

(54) METHOD OF PASSIVE VOLTAGE CONTROL IN A SODIUM-ION BATTERY

(71) Applicants: Sharp Kabushiki Kaisha, Osaka (JP); Faradion Limited, South Yorkshire (GB)

(72) Inventors: Joshua Charles TREACHER, Oxford (GB); Katherine Louise SMITH, Oxford (GB); Emma KENDRICK, Oxford (GB)

(21) Appl. No.: 15/764,092

(22) PCT Filed: Oct. 26, 2016
(86) PCT No.: PCT/JP2016/004703

§ 371 Date: Mar. 28, 2018

(30) Foreign Application Priority Data
Oct. 30, 2015 (GB) 1519245.3

(51) Int. Cl. H01M 10/054; H01M 4/587; H01M 4/525; H01M 4/505; H01M 4/1391; H01M 4/1393; H01M 10/058; H01M 10/44

(52) U.S. Cl. CPC H01M 10/054; H01M 4/587; H01M 4/525; H01M 4/505; H01M 2004/028; H01M 4/1393; H01M 10/058; H01M 10/44; H01M 4/1391

(57) ABSTRACT

One aspect of the present invention provides a method comprising: manufacturing a sodium ion secondary cell having an anode and a cathode, the anode comprising a negative electrode active material comprising disordered carbon on an anode substrate, and the cathode comprising a comprising a nickel-containing sodium oxide positive electrode active material on a cathode substrate; and in a cycling phase, charging the cell to a first voltage; wherein the ratio of the mass of the negative electrode active material to the mass of the positive electrode active material is greater than 0.37 and is less than 1.2.

### TECHNICAL FIELD

One aspect of the present invention relates to a secondary sodium-ion battery.

An active material of the positive electrode is sodium nickel containing metal oxide and an active material of the negative electrode is a disordered carbon and mixtures thereof. A ratio of masses between active components within the cell-stack is selected which leads to the creation of a useful secondary sodium cell.

### BACKGROUND ART

### BACKGROUND

Sodium ion batteries are very similar in many ways to lithium ion batteries that are in common use today; they are both reusable secondary batteries that comprise an anode (negative electrode), a cathode (positive electrode) and an electrolyte material, both are capable of storing energy and they both charge and discharge via a similar reaction mechanism. When a sodium-ion battery (or lithium-ion battery) is charging, Na⁺(or Li⁺) ions deintercalate and migrate towards the anode whilst charge balancing electrons pass from the cathode through the external circuit containing the charger and into the anode of the battery. During discharge the same process occurs but in the opposite direction. Once a circuit is complete electrons pass back from the anode to the cathode and the Na⁺(or Li⁺) ions travel back to the cathode.

Lithium-ion battery technology has been utilised in many applications, and is used in portable devices extensively; however lithium is not a hugely abundant material and is expensive to use in large scale applications. Sodium-ion technology is still a new technology but the high abundance of sodium on the earth and a significantly lower cost of sodium compared to lithium gives sodium ion an advantage over lithium ion technologies. Researchers predict that sodium ion will provide a cheaper and more durable way to store energy in the future, especially for large scale applications such as grid level energy storage.

### PRIOR ART

U.S. Pat. No. 6,872,492 B2 describes the use of a polyanion compound for the cathode of a sodium ion battery.

WO2014057258 A1 describes the use of a doped nickelate material in an electrode as the charge storage material. An unexpected anomalous ‘overcharge’ reaction is discussed.

JP2007335143A proposes a lithium secondary battery in which the discharge capacity X of the positive electrode and the discharge capacity Y of the negative electrode (a hard carbon) satisfy Y/X≥1.3. This is specified for lithium-ion cell and therefore is specific to the chemistry of these cells.

US 2014/0234719 A1 describes a lithium secondary battery using lithium mixed metal oxide positive electrode material and an alloy anode material. It proposes that the first cycle irreversible capacity of the positive electrode (the amount of lithium capacity of the electrode that is lost in the first charge/discharge cycle, expressed as a percentage) is greater than or equal to the first cycle irreversible capacity of the negative electrode. A comparison is drawn in the text between three cells that use LiNi_{2/3}Mn_{1/3}O₂, LiCoO₂ and LiNi_{1/3}Mn_{1/3}Co_{1/3}O₂ respectively as positive electrode material, each with a Si₇₁Fe₂₅Sn₄ based negative electrode material. This patent is specific to anodes based on alloys and again specific to lithium chemistry.

EP 1771912 B1 describes a mass ratio of anode to cathode. This specification is part of the broader invention which is set in the context of a lithium secondary battery in which the active materials fall within a particular particle size range and the electrolyte contains 2-fluorotoluene, 3-fluorotoluene.

### CITATION LIST

### Patent Literature

PTL 1: U.S. Pat. No. 6,872,492 B2
PTL 2: WO 2014057258 A1
PTL 3: JP 2007335143 A
PTL 4: US 2014/0234719 A1
PTL 5: EP 1771912 B1

### SUMMARY OF INVENTION

One aspect of the present invention provides a method comprising: manufacturing a sodium ion secondary cell having an anode and a cathode, the anode comprising a negative electrode active material comprising disordered carbon on an anode substrate, and the cathode comprising a comprising a nickel-containing sodium oxide positive electrode active material on a cathode substrate; and in a cycling phase, charging the cell to a first voltage; wherein the ratio of the mass of the negative electrode active material to the mass of the positive electrode active material is greater than 0.37 and is less than 1.2.

### BRIEF DESCRIPTION OF DRAWINGS

FIG. 1 is voltage vs. capacity plot for the first two cycles of a sodium half-cell containing an exemplary sodium nickel-based metal oxide compound as the positive active material. The upper voltage limit is 4.2V vs. Na/Na⁺. A constant current constant voltage program was used with the current used 10 mAg⁻¹.

FIG. 2 is voltage vs. capacity plot for the first two cycles of a sodium half-cell containing an exemplary sodium nickel-based metal oxide compound as the positive active material. The upper voltage limit is 4V vs. Na/Na⁺. A constant current constant voltage program was used with the current used 10 mAg⁻¹.

FIG. 3 is voltage vs. capacity plot for the first two cycles of a sodium half-cell containing an exemplary disordered carbon compound as the negative active material. The lower voltage limit is 10 mV vs. Na/Na⁺. A constant current constant voltage program was used with the current used 50 mAg⁻¹.

FIG. 4 is differential capacity vs. voltage plot for the first two cycles of a sodium half-cell containing an exemplary disordered carbon compound as the negative active material. The lower voltage limit is 10 mV vs. Na/Na⁺. A constant current constant voltage program was used with the current used 50 mAg⁻¹.

FIG. 5 is graph showing specific capacity on first charge and discharge of a series of electrochemical cells with varying ratios of positive electrode active mass to negative electrode active mass.

FIG. 6 is graph showing 1st cycle galvanic efficiency and first cycle galvanic loss as a function of mass ratio between positive electrode active material and negative electrode active material.

FIG. 7 is graph showing average voltage on first charge of cells as a function of mass ratio between positive electrode active material and negative electrode active material.

FIG. 8 is graph showing individual potential of the positive electrode, negative electrode and cell as a function of specific capacity. The cell has a mass ratio between positive electrode active material and negative electrode active material of 0.62.

FIG. 9 is graph showing individual potential of the positive electrode, negative electrode and cell as a function of specific capacity. The cell has a mass ratio between positive electrode active material and negative electrode active material of 1.19.

FIG. 10 is schematic of pouch cell with central cell-stack, tabs and laminate pouch.

FIG. 11 is schematic of a three electrode Swagelok format cell.

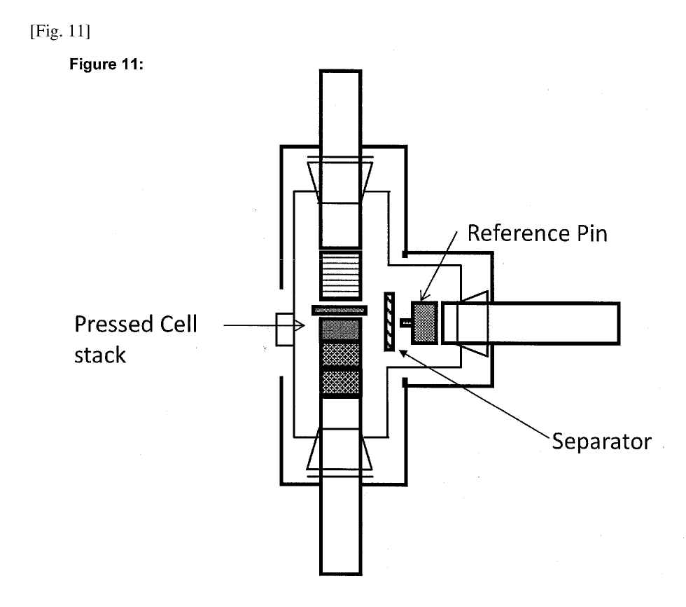

### DESCRIPTION OF EMBODIMENTS

One aspect of the present invention aims to at least partially overcome problems commonly faced in the construction of a useful sodium-ion batteries such as rapid capacity fade with repeated charge and discharge cycles, poor safety characteristics and low energy specific to cell mass . We have found that control of the mass ratio between the active charge storage materials of the positive and negative electrodes within the cell stack leads to a method of passive control over the maximum and minimum voltages reached by these electrodes in the cycling phase and thus improvements in many aspects of the resulting cell characteristics.

Hereinafter, one aspect of the present invention will be explained in more detail and preferred embodiments disclosed.

As described above the mass ratio is defined as the ratio between the mass of active charge storing materials of the negative electrode and the mass of active charge storing materials of the negative electrode One preferred embodiment of the mass ratio balance is between 0.37 and 1.2 another even more preferred embodiment is between 0.5 and 0.9.

A preferred embodiment of the invention uses disordered carbon as the negative electrode charge storage material with this optionally mixed with other typical low voltage charge storage compounds such as but not limited to sodium alloys, carbonaceous materials, inorganic oxides, inorganic chalcogenides, nitrides, metal complexes or organic polymer compounds.

Another preferred the invention uses a sodium metal oxide (NMO) as the majority charge storage material of the positive electrode. Another even more preferred embodiment is for this charge storage metal to be a nickel containing sodium metal oxide according to the following formula:

AᵤM¹ᵥM²_{w}M³ₓM⁴_{Y}M⁵_{z}O_{2±c}, where:

A comprises either sodium or a mixed alkali metal in which sodium is the major constituent;

M¹ is nickel in an oxidation state between +2 and +4;

M² comprises a metal in oxidation state +4 selected from one or more of manganese, titanium and zirconium;

M³ comprises a metal in oxidation state +2, selected from one or more of magnesium, calcium, copper, zinc and cobalt;

M⁴ comprises a metal in oxidation state +4, selected from one or more of titanium, manganese and zirconium;

M⁵ comprises a metal in oxidation state +3, selected from one or more of aluminium, iron, cobalt, molybdenum, chromium, vanadium, scandium and yttrium;

U is in the range 0<U<1;

V is in the range 0.25<V<1;

W is in the range 0<W<0.75;

X is in the range 0≤X<0.5;

Y is in the range 0≤Y<0.5;

Z is in the range 0≤Z<0.5;

U+V+W+X+Y+Z≤3;and

c≥0.0.

The electrolyte that may be used in one embodiment of the present invention includes a salt represented by the formula of A⁺B , wherein A⁺ represents an alkali metal cation selected from the group consisting of Na⁺, Li⁺, K⁺ and combinations thereof and B− represents an anion selected from the group consisting of PF₆⁻, BF₄⁻, Cl⁻, Br, I , ClO₄, AsF₆, CH₃CO₂, CF₃SO₃, N(CF₃SO₂)₂, C(CF₂SO₂)₃ and combinations thereof, the salt being dissolved or dissociated in an organic solvent is selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (y-butyrolactone) and mixtures thereof. However, the electrolyte that may be used in one embodiment of the present invention is not limited to the above.

Half-cells are well-known within the field as electrochemical cells that use an alkali metal as the counter electrode to the electrode being assessed. They are useful experimental cells in which electrode active materials can be independently assessed. As all of the alkali metal can be considered ‘active’ and the quantity of alkali metal is typically far in excess of that of the electrode under assessment these cells are also useful for determination of expected specific capacity values and first cycle losses, although differences naturally arise when compared with a ‘full-cell’ which consists of two electrodes, neither of which is an alkali metal. In addition as the voltage profile of the Na/Na⁺ half-reaction can be considered flat at 0V vs. Na/Na⁺ the cell voltage of the cell can be approximately as the absolute voltage of the electrode containing the material undergoing assessment.

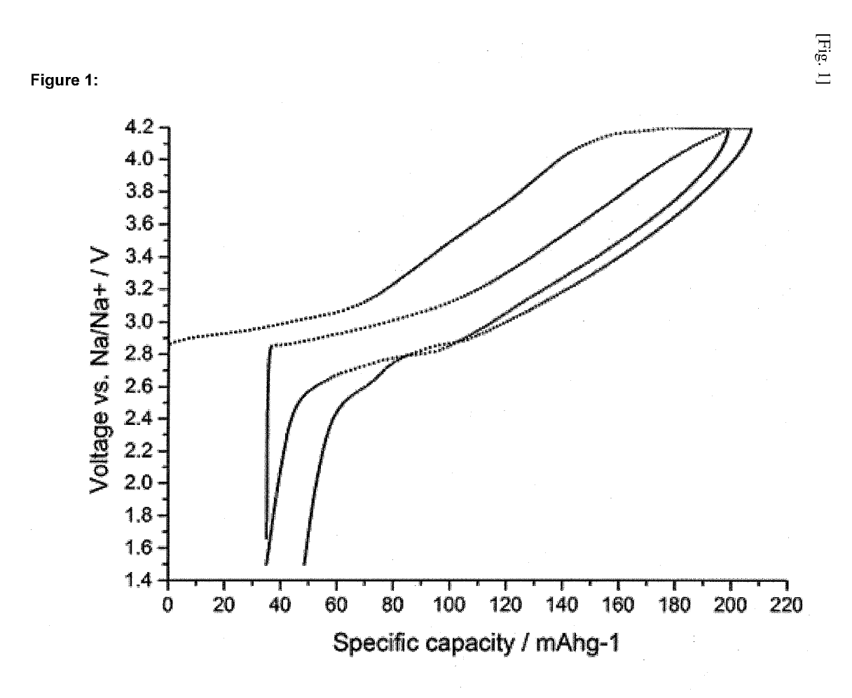

Found in FIG. 1 is the voltage vs. specific capacity profile of a half-cell of an exemplary NMO material, NaNi_{0.33}Mn_{0.33}Mg_{0.167}Ti_{0.167}O₂. This data is included and discussed as an illustrative example. The cell was charged to 4.2V and then discharged to 1.5V before this cycle was repeated. On the first charge almost 200 mAhg⁻¹ of charge is passed and three distinct ‘plateaus’ or reaction events can be seen. The last of these in the voltage region from 4 to 4.2V vs. Na/Na⁺ is an irreversible event (fading on subsequent cycles) which it is postulated may be due to irreversible structural rearrangements of the active material and possible oxygen loss. At even higher voltages oxidation of the electrolyte will occur with a poor performance of the cell occurring as a result. The discharge capacity is around 160 mAhg⁻¹ which represents a first cycle loss of 20%.

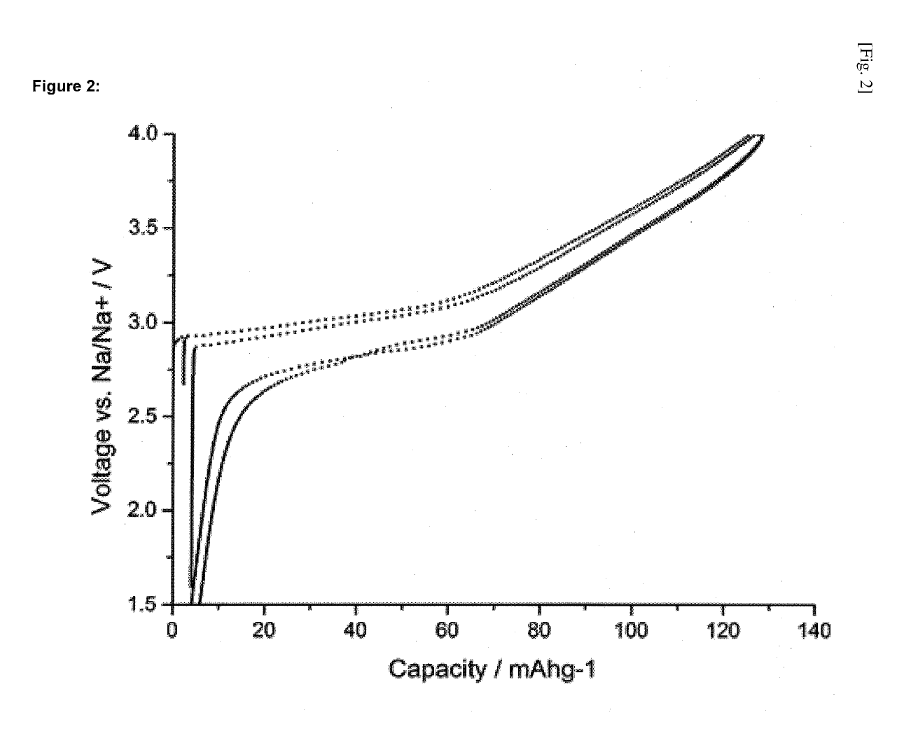

Comparing FIG. 1 to FIG. 2 in which the half-cell is cycled to 4V only, it can be seen that the irreversible event at greater than 4V is avoided in FIG. 2 and thus it is postulated that the structure of the active material is preserved. Although the charge capacity obtained by cycling to 4V only is lower than the one seen in FIG. 1 at 128 mAhg⁻¹, the first cycle loss is greatly reduced to only 3.2% and thus 124 mAhg⁻¹ is obtained on first discharge. This comparison exemplifies how control, i.e. via the use of mass ratio, over the voltage reached by the positive electrode material is particularly important in the case of NMO materials and of specific importance in the region above 4V and that this can have an impact on the so-called first cycle loss.

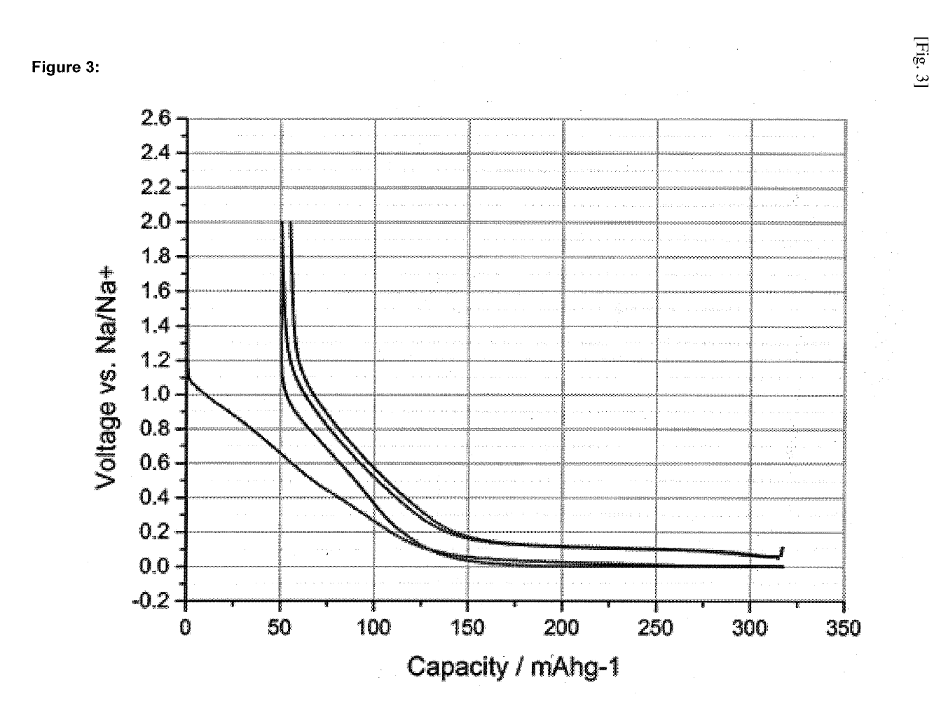

In a further, similar assessment FIG. 3 shows the voltage vs. specific capacity plot of a half-cell in which a disordered carbon, in this example hard carbon, is the active material. The voltage profile is exemplary of this type of active material's reaction with sodium, with a characteristic sloping profile during the first portion of the discharge followed by an almost flat portion a little higher than the plating potential of sodium (around 0V vs. Na/Na⁺). The plating of sodium is an unsafe and undesirable reaction as described fully later in this document.

Through control of the mass ratio of negative electrode active material to positive electrode active material in a full cell, the extent to which this flat portion of the disordered carbon's voltage profile is accessed can be changed and therefore the likelihood of the sodium plating reaction occurring controlled. Conversely due to the extremely gradual slope of the ‘flat’ portion of the negative electrode's voltage profile, the maximum voltage reached by the positive electrode can be controlled accurately by changing the mass ratio. If only the sloping part of the negative electrode's voltage profile is accessed, as in the case of a ratio of the mass of active charge storing materials in the negative electrode to the mass of active charge storing materials in the positive electrode (this will be referred to as “(−/+”) that is around 0.9 or greater, then the changes to the maximum voltage reached by the positive electrode will differ to a much greater extent with changing mass ratio in this region making fine control difficult.

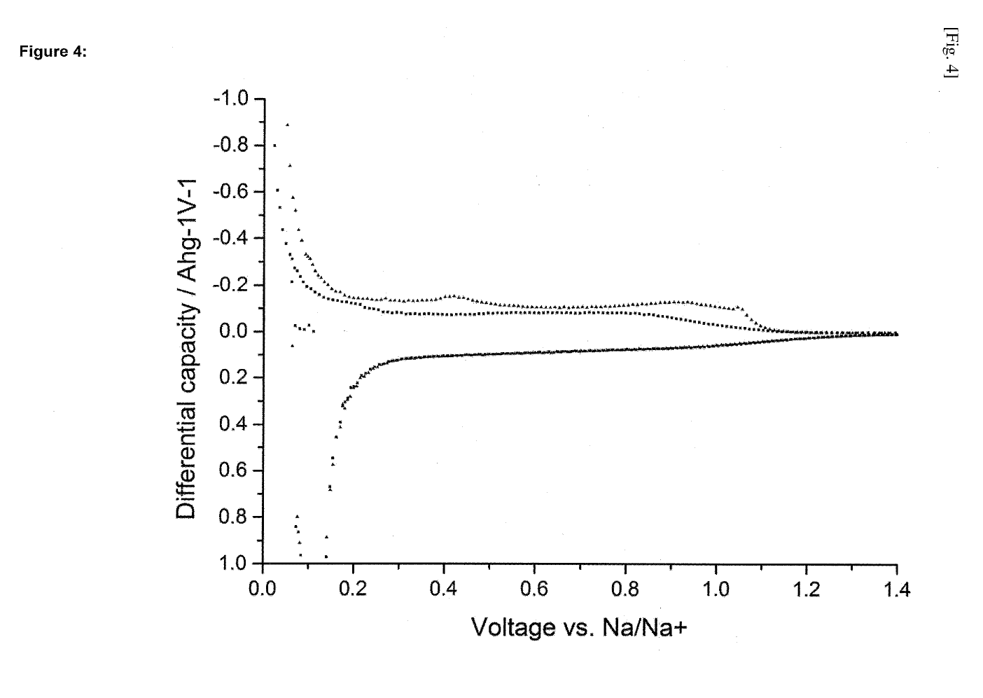

In the example half-cell given in FIG. 3 which utilises a disordered carbon active material the charge passed on initial discharge is 315 mAhg⁻¹ which is reduced to 264 mAhg⁻¹ upon first charge. The irreversible losses in the case of disordered carbons are typically due to their operation at low potentials which leads to the degradation of electrolyte onto their surface. This new interface is the ‘solid electrolyte interface’ (SEI) layer which is a well-known phenomenon by those skilled in the art. In this exemplary case an electrolyte of 1M NaPF₆ in a solvent of propylene carbonate, ethylene carbonate and diethyl carbonate in a 1:1:1 ratio by volume was used. It can be seen in the differential capacity vs. voltage plot seen in FIG. 4 that by comparing the first discharge (uppermost broken line) and second discharge (middle line in FIG. 4, also a broken line) the irreversible events which are postulated to be the formation of an SEI layer are witnessed. This process is found to occur as two separate reaction events between 1.2 and 0.2V vs. Na/Na⁺. It is postulated that changing the mass ratio will affect the relative proportion of irreversible to reversible redox events within this first cycle within these compounds.

According to one embodiment of the present invention a secondary sodium-ion cell, consisting of a negative electrode and a positive electrode, with disordered carbon and a NMO as the respective anode and cathode electrode active materials, is characterised in that the capacity balance is satisfied by controlling the mass balance between the negative electrode active material and the positive electrode active material within the cell stack, and by controlling the voltage in the cycling phase.

One embodiment of the present invention characterised by the above-mentioned preferred mass ratio provides the following effects.

(1) The sodium-ion secondary cell utilising disordered carbon and a sodium metal oxide as the active charge storing substituents can show a lower capacity fade compared to like batteries prepared in a conventional manner.

A situation resulting in rapid capacity fade is when the charge storage capacity of the negative electrode is significantly higher than that of the positive electrode i.e. at high mass ratio (−/+). Here the maximum voltage reached by the positive electrode will be high. It is however undesirable for the maximum voltage reached by the cathode to become too high, since side reactions such as possible reaction of the electrolyte solvents with the sodium metal oxide can occur if the voltage at the positive electrode exceeds around 4.3V, and detrimental irreversible structural rearrangements including loss of oxygen gas may also occur at/above this cathode voltage. These both will lead to rapid degradation of the capacity of the provided sodium-ion secondary battery with repeated cycling.

In addition if the mass ratio is low, for example <0.5, then sodium plating may occur on the negative electrode surface, this sodium metal is highly reactive to the electrolyte causing an increasingly large solid electrolyte layer to form which results in degradation of the cell e.g. capacity fade.

(2) The sodium-ion secondary battery utilising disordered carbon and a sodium metal oxide as the active materials according to one embodiment of the present invention demonstrates increased safety characteristics compared to like batteries prepared in a conventional manner.

As already detailed disordered carbon's fully utilised reaction with sodium ions reaches potentials that are close to that of the sodium plating potential (0V vs. Na/Na⁺) This makes control of the minimum voltage reached by the negative electrode particularly important in the case of sodium ion batteries in order to avoid this undesirable sodium plating reaction. When the charge storage capacity of the positive electrode is significantly higher than that of the negative electrode i.e. at a low mass balance (−/+), the minimum voltage reached by the negative electrode will be close to zero, and the likelihood of sodium metal plating onto the electrode surface will be high. (As described later, a mass ratio of at least around 0.37 or 0.5 or 0.55, or greater, may be desirable to reduce the risk of plating occurring.)

In addition to the capacity fade that is incurred as a result of the presence of sodium metal within the cell, the sodium metal is well known to be deposited in such a way as to create a morphology that is often referred to as ‘mossy’ i.e. it consists of clusters of sharp extrusions called dendrites which grow with repeated cycles. These dendritic growths can piece through the separator leading to a short circuit of the sodium-ion secondary cell and rapid discharge of the battery. This rapid discharge of the battery can lead to a rapid increase in the temperature of the battery potentially leading to the ignition of the flammable electrolyte.

One embodiment of the current invention can control the minimum voltage reached by the disordered carbon containing negative electrode in order to minimise the likelihood of the dangerous plating reaction from occurring and leading to the production of a sodium-ion secondary cell with increased safety characteristics.

In addition the voltage reached by the positive electrode can be controlled avoiding the release of flammable and unsafe gases at high potentials e.g. oxygen.

(3) Furthermore, the sodium-ion secondary cell according to one embodiment of the present invention has an optimised energy density for a disordered carbon vs NMO system.

The optimised energy density within the bounds of one embodiment of the invention results from effective utilisation of both charge storage materials so that the irreversible capacity losses during the first cycle are minimised and thus the utilised capacity with respect to mass maximised, whilst the voltage difference during cycling is maximised which leads to the increase in energy density.

(Cell Manufacture Procedure)

One embodiment of this invention relates to the use of sodium metal oxide and disordered carbon as the charge storage materials (or ‘active materials) in sodium-ion secondary cells. The first step in the creation of the test cells used once the material has been acquired is the creation of the negative and positive electrodes.

All active materials can be optionally milled before use to reduce particle size. A slurry can then be made for each electrode, i.e. a slurry for a positive and negative electrode may be obtained separately by mixing the above-described active materials with a binder and dispersion medium. Each of the slurries will preferably contain a small amount of conductive agent.

There is no particular limitation in the conductive agent, as long as the conductive agent is an electrically conductive material. Particular examples of the conductive agent that may be used include conductive carbon fiber, natural graphite, artificial graphite carbon black, graphite powder or carbon fiber and carbon black such as acetylene black, ketchen black, furnace black or thermal black being preferred.

The binder that may be used includes thermoplastic resins, thermosetting resins or combinations thereof.

Among such resins, polyvinylidene difluoride (PVDF), styrene butadiene rubber (SBR) or polytetrafluoroethylene (PTFE) and copolymers of these are preferable.

The slurry is mixed until homogenous.

Once the slurry is determined to be well mixed it is cast on a current collector which is preferably copper, aluminium, a mix or modified variants to achieve the desired coating height and size using an automated doctor blade or reel-to-reel coater. The solvent which remains in the coating is removed via a drying process such for example by heating the coating under vacuum.

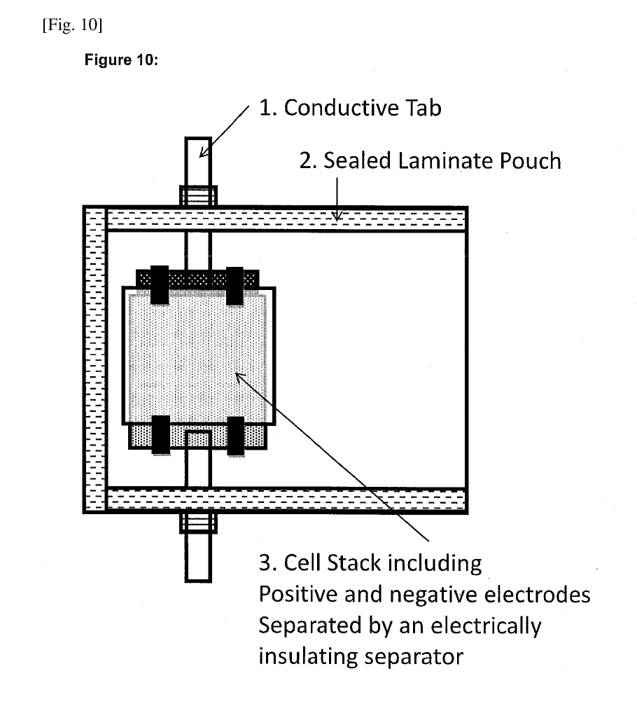

The cells are made in a stack configuration as shown in FIG. 10.

The electrodes are cut to the desired shape and optionally calendared to increase their conductivity and improve the resulting volumetric energy density. Conductive tabs are welded to the electrodes (1 in FIG. 10).

The electrodes are then matched to achieve the desired mass ratio according to examples the examples in table 1 and table 2. (3 within FIG. 10). The cell is created by the introduction of a separator material which is electrically insulating but allows the flow of charge carrying ions. Although there is no particular limitation in the separator that may be used in one embodiment of the present invention, porous separators may be used. Particular examples of porous separators include polypropylene-based, polyethylene-based and polyolefin-based porous separators.

An electrolyte is introduced to act as a medium in which the charge carrying ions can flow with the preferred embodiments as already described. Finally the wetted cellstack is sealed within the pouch material (2 within FIG. 10) in such a way that the tabs allow connection to an external circuit whilst the cell-stack is isolated from the external environment. The pouch material is preferably a laminate containing aluminium.

(Measurement of Cell Component Voltages During Cycling)

Table 1 shows results obtained for cells in which the cathode active material is NaNi_{0.33}Mn_{0.33}Mg_{0.167}Ti_{0.167}O₂ and the anode active material is hard carbon. The electrodes were made as per the manufacturing method described above. The results of Table 1 were obtained using a three electrode set-up in a SwagelokTM type configuration. The additional electrode is a reference electrode, in this case sodium metal, with a known potential i.e. sodium metal which has a potential of −2.71V vs. standard hydrogen electrode (SHE) which can be used to work out the potential of the positive and negative electrodes as any experiment progresses. The specific voltages on the anode and cathode vs Na/Na⁺ were observed with the different mass balances as shown in Table 1 when the cells were cycled in the stated voltage ranges.

TABLE 1
Examples of controlled voltage limits

| | | Charged to | Voltage of | Voltage of |
|---|---|---|---|---|
| | Mass ratio | cell voltage | negative | positive |
| Example | (−/+) | of/V | electrode/V | electrode/V |
| 1 | 0.36 | 4.2 | 0.000 | 4.201 |
| 2 | 0.40 | 4.2 | 0.018 | 4.218 |
| 3 | 0.47 | 4.2 | 0.035 | 4.235 |
| 4 | 0.51 | 4.2 | 0.039 | 4.238 |
| 5 | 0.58 | 4.2 | 0.063 | 4.262 |
| 6 | 0.62 | 4.2 | 0.078 | 4.277 |
| 7 | 0.64 | 4.2 | 0.071 | 4.270 |
| 8 | 0.71 | 4.2 | 0.091 | 4.291 |
| 9 | 0.76 | 4.2 | 0.081 | 4.28 |
| 10 | 0.79 | 4.2 | 0.072 | 4.271 |
| 11 | 0.98 | 4.2 | 0.108 | 4.307 |
| 12 | 0.56 | 4 | 0.037 | 4.056 |
| 13 | 0.62 | 4 | 0.092 | 4.092 |
| 14 | 0.72 | 4 | 0.099 | 4.099 |
| 15 | 0.85 | 4 | 0.152 | 4.153 |
| 16 | 0.39 | 3.8 | 0.056 | 3.856 |
| 17 | 0.59 | 3.8 | 0.114 | 3.914 |
| 18 | 0.75 | 3.8 | 0.152 | 3.952 |
| 19 | 0.85 | 3.8 | 0.198 | 3.998 |

(Detailed Description of Given Figures)

Entries 1 to 11 in Table 1 show the minimum voltage reached by the negative electrode and the maximum voltage reached by the positive electrode as the mass ratio is varied, in pouch cells made by the manufacturing method described above, and the cells are charged to an overall voltage of 4.2V in the cycling phase. The maximum voltage reached by the positive electrode and the minimum voltage reached by the negative electrode both increase as the mass ratio increases. This is due to a lower total utilisation of the available storage sites on the disordered carbon meaning that the lowest potential reached is increased. Accordingly, by manipulation of the mass ratio and the overall voltage to which the cell is charged in the formation charge phase, the maximum and minimum voltages at the cathode and anode on charge and discharge can be controlled. For example, Table 1 shows that the minimum voltage reached by the negative electrode increases as the mass ratio is varied, and the mass ratio may be selected to provide a value for the minimum voltage reached by the negative electrode that eliminates, or substantially reduces, the risk of plating occurring. The overall voltage to which the cell is charged in the cycling charge phase may then be selected based on the chosen mass ratio and on the maximum voltage that is desired at the positive electrode in the cycling charge phase, for example to keep the maximum voltage at the positive electrode in the cycling charge phase below a value at which undesired effects might occur.

As an example, for cells having NaNi_{0.33}Mn_{0.33}Mg_{0.167}Ti_{0.167}O₂ as the cathode active material and hard carbon as the anode active material, Table 1 shows that a mass ratio of 0.58 or 0.62 (Examples 5 and 6 in Table 1) are examples of suitable mass ratios—they give a minimum voltage at the anode in the cycling phase of 0.063V or 0.78V which is sufficiently above zero to eliminate the risk of plating but give a maximum voltage at the cathode (when the cell is charged to 4.2V) of around 4.27 or 4.28V which is unlikely to result in overcharging of the cathode material. However example 1 (mass ratio=0.36) and example 11 (mass ratio of 0.98) of table 1 are less suitable, since example 1 gives a minimum anode voltage of 0V leading to a high risk of plating while example 11 gives a maximum cathode voltage of 4.307V (when the cell is charged to 4.2V) leading to a risk of damaging the cathode material through overcharging. Table 1 shows that, for cells having NaNi_{0.33}Mn_{0.33} Mg_{0.167}Ti_{0.167}O₂ as the cathode active material and hard carbon as the anode active material, the mass ratio is preferably 0.4 or greater, and more preferably is greater than around 0.5 or greater than around 0.55, or even greater, to ensure that the minimum anode voltage during cycling is reliably above a value at which plating occurs. Table 1 also shows that for cells having NaNi_{0.33}Mn_{0.33}Mg_{0.167}Ti_{0.167}O₂ as the cathode active material and hard carbon as the anode active material, the mass ratio is preferably 0.9 or less (when the cell is charged to 4.2V) so that the maximum voltage at the cathode is not likely to cause overcharging.

It will be seen from Table 1 that there may be a range of possible mass ratios that eliminate (or significantly reduce) the risk of plating at the anode and overcharging at the cathode. Where this is so, the formation charge phase may be used to derive a further constraint on the mass ratio. As noted, an irreversible capacity loss is observed on the cathode in the formation charge phase, and an irreversible capacity loss is observed on the anode in the formation charge phase. The mass ratio, and the maximum voltage to which the cell is charged in the formation charge phase are preferably selected such that the loss at the cathode in the formation charge phase and the loss at the anode in the formation charge phase are as close to being equal as possible, to reduce the overall capacity loss observed in the formation charge phase.

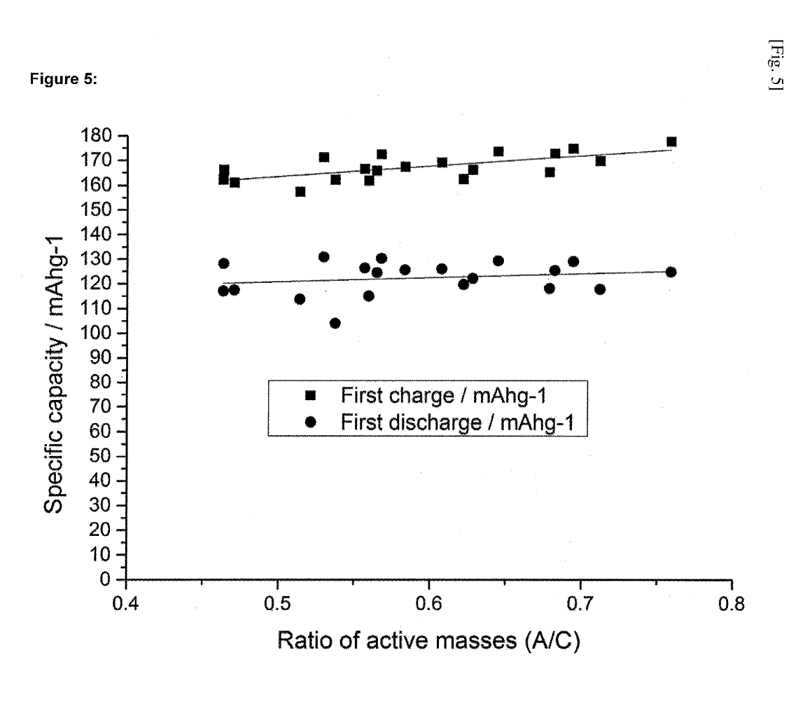

FIG. 5 shows how the specific charge and discharge capacities change with increasing mass ratio; these results were again obtained using cells having NaNi_{0.33}Mn_{0.33}Mg_{0.167}Ti_{0.167}O₂ as the cathode active material and hard carbon as the anode active material. Both increase as the mass ratio increases with the rate of increase less for the discharge capacity than for the charge capacity. The charge capacity or charge passed on first charge includes charge passed due to sodium ions deintercalating and migrating from the positive electrode to the negative electrode, due to the applied potential. It will also include however an element of additional passed charge which will be due to irreversible processes such as the formation of a layer of degraded electrolyte on the surface of the disordered carbon. This is a well-known phenomenon amongst those familiar with the field and is a large factor in the discrepancy between the specific capacity on first charge and first discharge.

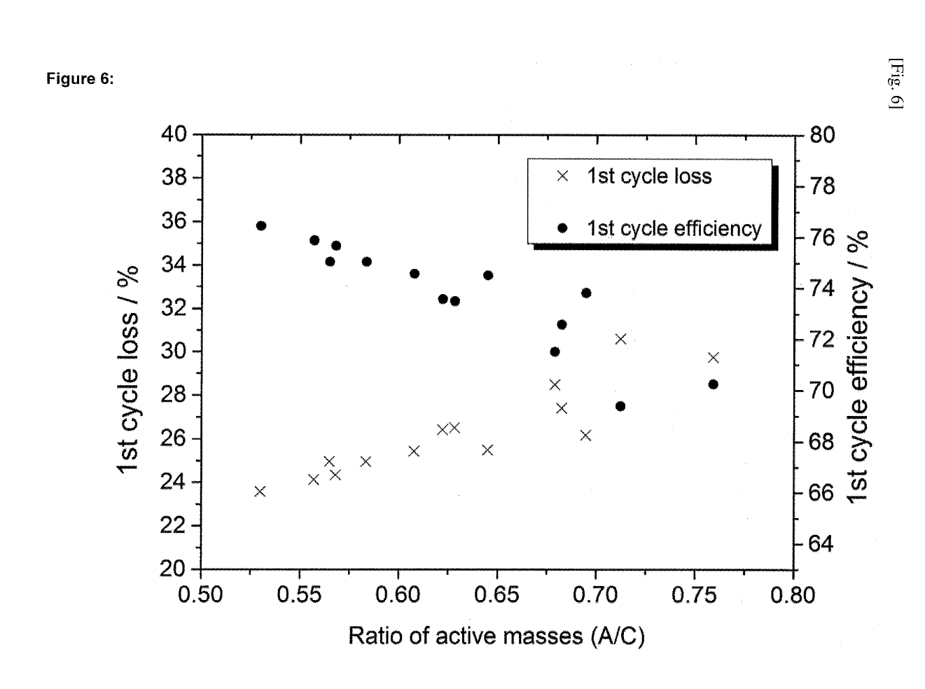

FIG. 6 plots the loss of capacity between first charge and discharge or by another metric, the galvanic efficiency of this first charge and discharge cycle against the mass ratio; these results were again obtained using cells having NaNi_{0.33}Mn_{0.33}Mg_{0.167}Ti_{0.167}O₂ as the cathode active material and hard carbon as the anode active material. A linear relationship can be seen between these two parameters and the mass ratio with the first cycle loss increasing with increasing mass ratio whilst the first cycle efficiency decreases. The capacity lost on the first cycle should be minimised in order to reduce the mass of required active materials. This demonstrates that the mass ratio can be manipulated in order to change the first cycle loss and first cycle efficiency.

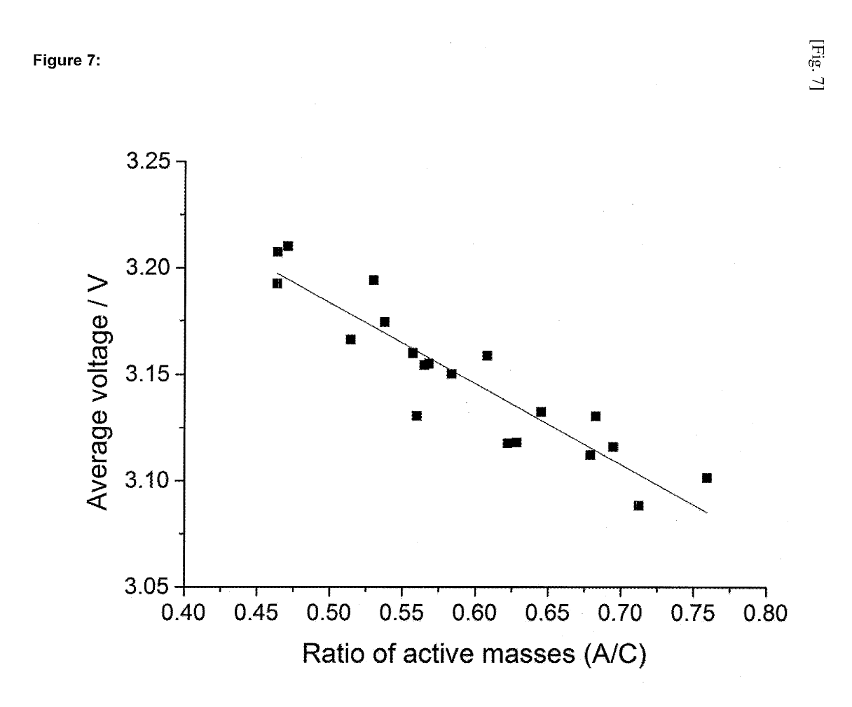

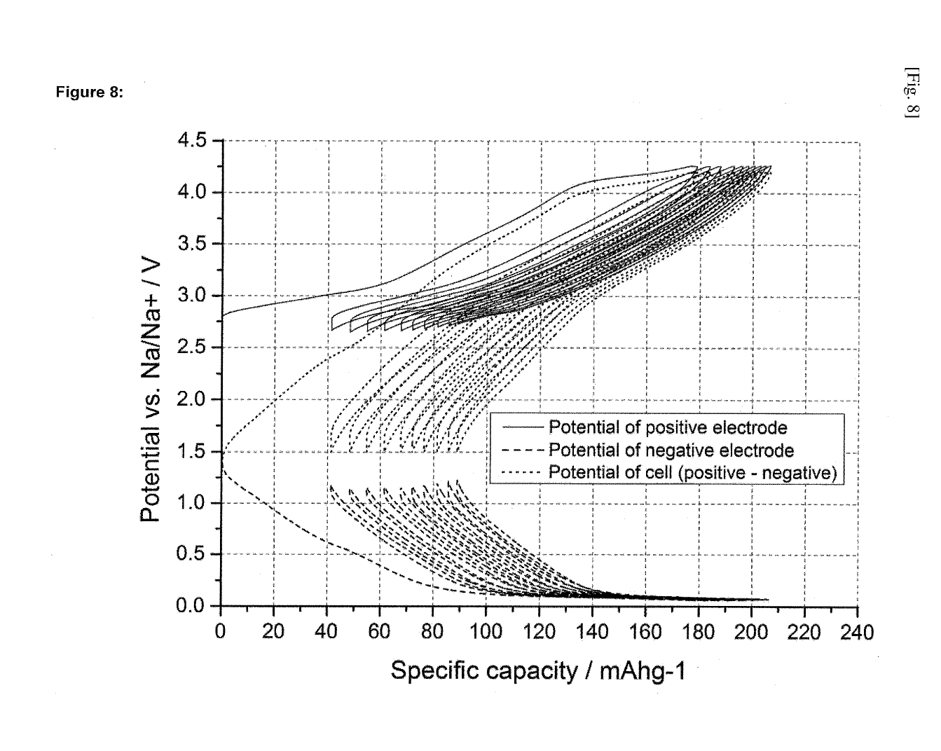

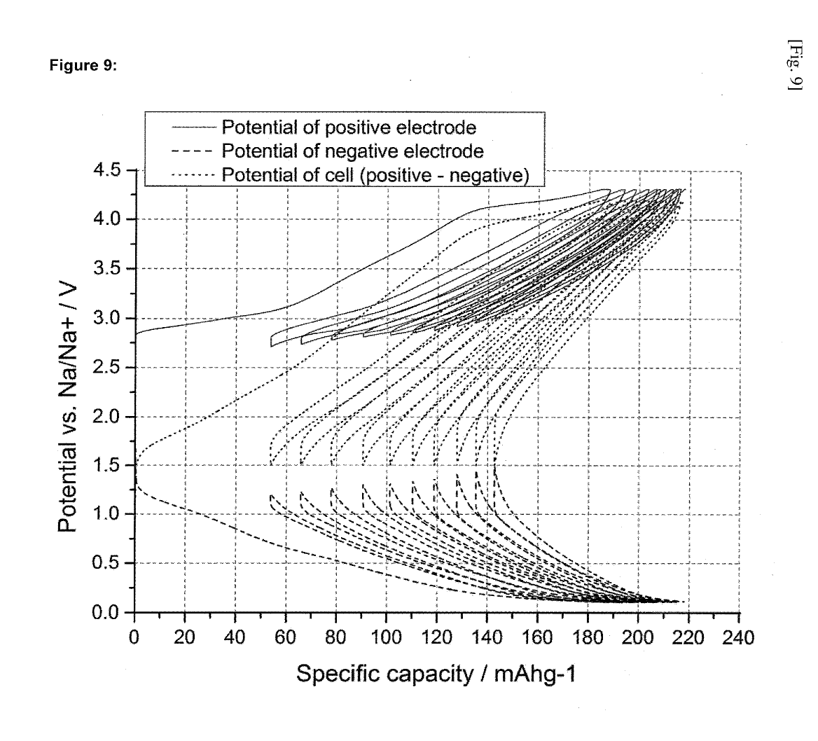

In FIG. 7 the average voltage of the first charge is shown versus the mass ratio; these results were again obtained using cells having NaNi_{0.33}Mn_{0.33}Mg_{0.167}Ti_{0.167}O₂ as the cathode active material and hard carbon as the anode active material. There is a clear relationship between the average voltage of first charge and the mass ratio with this approximated as linear. As the mass ratio increases there is a lower utilisation of the disordered carbon and a higher proportion of the sloping voltage profile of disordered carbon is seen, this is what decreases the average voltage of the cell with increasing mass ratio. The difference in the proportion of sloping profile to flat profile can be seen clearly when comparing FIG. 8 & FIG. 9 in which the charge and discharge profiles of the negative electrode (a disordered carbon electrode) and the charge and discharge profiles of the positive electrode are shown, together with the difference between them which represents the charge and discharge profiles of the cell. FIG. 8 is for a cell having a low mass ratio, that is having ratio of the mass of active charge storing materials in the negative electrodes to the mass of active charge storing materials in the positive electrodes of 0.62, whereas FIG. 9 is for a cell having a high mass ratio, that is having ratio of the mass of active charge storing materials in the negative electrodes to the mass of active charge storing materials in the positive electrodes of 1.19.

Attention is drawn to the representative low mass cell in FIG. 8 and in particular to the voltage profile of the negative electrode which is shown to cycle stably with little increase in the hysteresis or difference in potential between charge and discharge seen over the course of the ten cycles shown. Comparing this to FIG. 9, a high mass ratio cell, it can be seen that the hysteresis is found to unexpectedly increase substantially over the ten cycles shown which leads to a lower energy efficiency of charge and discharge and a higher capacity fade rate despite the higher minimum voltage, due to the higher mass ratio (see Table 1), reached by the negative electrode. By keeping the mass ratio below the high value of 1.19 seen in FIG. 9, for example to around 0.9 or below, the lifetime of the cell can be improved as can be seen in Table 2 which demonstrates the difference in capacity retention over ten cycles, comparing the low mass ratio cell and high mass ratio cell seen in FIG. 8 & FIG. 9 respectively. The results of FIGS. 8 and 9, and Table 2, were again obtained using cells having NaNi_{0.33}Mn_{0.33}Mg_{0.167}Ti_{0.167}O₂ as the cathode active material and hard carbon as the anode active material.

TABLE 2

| | Mass ratio = 1.19 | | Mass ratio = 0.62 | |
|---|---|---|---|---|
| | Charge | Discharge | Charge | Discharge |
| | capacity/ | capacity/ | capacity/ | capacity/ |
| Cycle | mAhg⁻¹ | mAhg⁻¹ | mAhg⁻¹ | mAhg⁻¹ |
| 1 | 188.3 | 134.6 | 178.8 | 137.5 |
| 2 | 140.4 | 128.3 | 142.2 | 135.2 |
| 3 | 132.8 | 120.6 | 139.3 | 132.9 |
| 4 | 125.7 | 113.0 | 138.0 | 131.3 |
| 5 | 116.3 | 105.6 | 134.5 | 128.3 |
| 6 | 107.0 | 98.0 | 130.7 | 126.3 |
| 7 | 100.1 | 91.6 | 128.6 | 124.1 |
| 8 | 94.4 | 85.4 | 126.4 | 121.4 |
| 9 | 87.3 | 79.8 | 123.3 | 119.1 |
| 10 | 80.9 | 73.4 | 120.9 | 117.6 |

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

Also, the described results were obtained using cells having NaNi_{0.33}Mn_{0.33}Mg_{0.167}Ti_{0.167}O₂ as the cathode active material and hard carbon as the anode active material. The invention is not limited to these materials, and examples of alternative cathodes include:

NaNi_{0.5-x/2}Ti_{0.5-x/2}AlₓO₂;

NaNi_{0.5-x/2}Mn_{0.5-x/2}AlₓO₂;

NaNi_{0.5-x}Mn_{0.5-x}MgₓTiₓO₂;

NaNi_{0.5-x}Mn_{0.5-x}Mg_{x/2}Ti_{x/2}AlₓO₂;

NaNi_{0.5-x}Mn_{0.5-x}CaₓTiₓO₂;

NaNi_{0.5-x}Mn_{0.5-x}CoₓTiₓO₂;

NaNi_{0.5-x}Mn_{0.5-x}CuₓTiₓO₂;

NaNi_{0.5-x}Mn_{0.5-x}ZnₓTiₓO₂;

NaNi_{0.5-x}Mn_{0.5-x}MgₓZrₓO₂;

NaNi_{0.5-x}Mn_{0.25-x/2}CaₓTi_{0.25+x/2}O₂;

NaNi_{0.5-x}Mn_{0.5}CaₓO₂;

NaNi_{0.5-x}Mn_{0.5-Y}CaₓTi_{Y}O₂;

LiNi_{0.5-x}Mn_{0.5-x}CuₓTiₓO₂;

LiNi_{0.5-x}Mn_{0.5-x}CaₓTiₓO₂,

LiNi_{0.5-x}Mn_{0.5-x}MgₓTiₓO₂;

LiNi_{0.5-x}Ti_{0.5-x}MgₓMnₓO₂;

NaNi_{0.5-x}Ti_{0.5-x}MgₓMnₓO₂;

NaNi_{0.5-x}Ti_{0.5-x}CaₓMnₓO₂;

NaNi_{0.5-x}Ti_{0.5-x}CuₓMnₓO₂;

NaNi_{0.5-x}Ti_{0.5-x}CoₓMnₓO₂;

NaNi_{0.5}Ti_{0.5-x}ZnₓMnₓO₂;

NaNi_{0.5-x}Mn_{0.5}MgₓO₂;

NaNi_{0.5-x}Mn_{0.5}CaₓO₂;

NaNi_{0.5-x}Mn_{0.5}CuₓO₂,

NaNi_{0.5-x}Mn_{0.5}CoₓO₂;

NaNi_{0.5-x}Mn_{0.5}ZnₓO₂;

NaNi_{0.5-x}Mn_{0.5-x}MgₓTi_{y}O₂;

NaNi_{0.5-x}Mn_{0.5-x}CaₓTi_{y}O₂;

NaNi_{0.5-x}Mn_{0.5-x}CuₓTi_{y}O₂;

NaNi_{0.5-x}Mn_{0.5-x}CoₓTi_{y}O₂;

NaNi_{0.5-x}Mn_{0.5-x}ZnₓTi_{y}O₂;

NaNi_{0.5-x}Mn_{0.25-x/2}MgₓTi_{0.25+x/2}O₂;

NaNi_{0.5-x}Mn_{0.25-x/2}CaₓTi_{0.25+x/2}O₂;

NaNi_{0.5-x}Mn_{0.25-x/2}CuₓTi_{0.25+x/2}O₂;

NaNi_{0.5-x}Mn_{0.25-x/2}CoₓTi_{0.25+x/2}O₂;

NaNi_{0.5-x}Mn_{0.25-x/2}ZnₓTi_{0.25+z/2}O₂;

NaNi_{0.5-x}Mn_{0.5-x}Mg_{x/2}Ti_{x/2}AlₓO₂;

NaNi_{0.5-x}Mn_{0.5-x}Ca_{x/2}Ti_{x/2}AlₓO₂;

NaNi_{0.5-x}Mn_{0.5-x}Cu_{x/2}Ti_{x/2}AlₓO₂;

NaNi_{0.5-x}Mn_{0.5-x}Co_{x/2}Ti_{x/2}AlₓO₂;

NaNi_{0.5-x}Mn_{0.5-x}Zn_{x/2}Ti_{x/2}AlₓO₂

The values of the mass ratio required to prevent, or reduce the risk of, plating at the anode during the cycling phase and/or to prevent overcharging of the cathode during the cycling phase will depend on the cathode material. The required mass ratio will be dependent upon the specific capacities observed in the anodes and cathodes, for example on the ratio of, or difference between, the specific capacity of the anode active material and the specific capacity of the cathode active material. Depending on the specific capacities of the anode and cathode, a mass ratio of 0.2 or greater may be sufficient to avoid plating at the anode, and/or overcharging at the cathode may not occur for a mass ratio below 1.4. More preferably, the mass ratio is greater than around 0.37 or around 0.4 and/or the mass ratio is less than around 1.2, since this range for the preferred mass ratio corresponds to ratios of the specific capacity of the anode and the specific capacity of the cathode that are likely to occur in practice. Typically a hard carbon anode has a specific capacity of 250-300 mAhg⁻¹ and the cathode capacity of a sodium nickel oxide material can be 100 mAhg⁻¹ to 200 mAhg⁻¹ depending upon the material. For a cell having an anode which has a specific capacity of 300 mAhg⁻¹ and a cathode of 100 mAhg⁻¹ the mass ratio would preferably be >0.74 to avoid plating at the anode and/or <1.2 to avoid overcharging of the cathode, but if the anode had specific capacity of 250 mAhg⁻¹ and the cathode had a specific capacity of 200 mAhg⁻¹ the preferred mass ratio would be >0.37 to avoid plating at the anode and/or <0.6 to avoid overcharging of the cathode. This corresponds to approximately a ±30% change in the desired mass ratio, compared to the desired values for the examples of Table 1 using a NaNi_{0.33}Mn_{0. 33}Mg_{0.167}Ti_{0.167}O₂ cathode, and illustrates the variations in the desired mass ratio that may occur for different material combinations owing to changes in the cathode and/or anode specific capacities.

(Overview)

A first aspect of the present invention provides a method comprising: manufacturing a sodium ion secondary cell having an anode and a cathode, the anode comprising a negative electrode active material on an anode substrate, and the cathode comprising a positive electrode active material on a cathode substrate; and in a cycling phase, charging the cell to a first voltage; wherein the ratio of the mass of the negative electrode active material to the mass of the positive electrode active material, and the value of the first voltage, are selected such that the minimum voltage applied to the anode in the cycling phase is sufficiently greater than zero to prevent formation of a metal layer on the anode.

The ratio of the mass of the negative electrode active material to the mass of the positive electrode active material, and the value of the first voltage, may be selected such that the maximum voltage applied to the cathode in the cycling phase is less than a voltage at which an irreversible loss of cathode charge capacity occurs.

A second aspect of the present invention provides a method comprising: determining, for a sodium ion secondary cell having an anode comprising a negative electrode active material on an anode substrate and a cathode comprising a positive electrode active material on a cathode substrate, a value for the mass ratio, of the mass of the negative electrode active material to the mass of the positive electrode active material, and a voltage, such that charging a cell having the determined mass ratio to the determined voltage in a cycling phase causes the minimum voltage applied to the anode in the cycling phase to be such as to prevent formation of a metal layer on the anode; manufacturing a metal ion secondary cell having a mass ratio equal to the determined mass ratio.

The ratio of the mass of the negative electrode active material to the mass of the positive electrode active material, and the value of the first voltage, may be selected such that charging a cell having the determined mass ratio to the determined voltage in the cycling phase causes the maximum voltage applied to the cathode in the cycling phase to be less than a voltage at which an irreversible loss of cathode charge capacity occurs.

As is known, during the first charge cycle of a secondary cell different processes occur compared with subsequent cycles. On the anode side of the cell a layer known as the solid electrolyte interphase (SEI) is created; some of the electrolyte components are not stable at the low anode experienced during charging and the product of this electrolyte decomposition forms a solid layer on the surface of the anode material. However, once this initial SEI layer has formed it can be impenetrable to the electrolyte molecules and electronically insulating, and further significant build-up of the SEI in subsequent charge cycles is suppressed. Metal ions however, can still pass through this layer to the active material. The formation of the SEI on the anode surface consumes some of the metal ions which originated from the cathode material; the metal ions incorporated in the SEI layer are no longer available for shuttling between the cathode and anode and therefore the capacity of the cell is reduced on subsequent cycles compared with the first cycle. This is observed as a first cycle capacity loss at the anode. There is also an observed first cycle loss on the cathode side of the cell. It is therefore known for a sodium ion secondary cell to initially undergo one or more “formation charge” cycles in which the cell is charged to a formation charge voltage, the SEI is formed, and a capacity loss is observed. The cell may then be used by being repeatedly charged to a “use voltage” and discharged, and this is known as the “use” phase or “cycling” phase.

While a capacity loss similar to the first cycle loss is not observed in the cycling phase, in practice the cell capacity slowly decreases as the cell is repeatedly cycled and this is known as “fading” of the cell capacity. Fading may for example occur if the cathode is overcharged during the cycling phase leading to damage of the cathode active material, or if the voltage at the anode during the cycling phase falls to a level at which “plating” may occur. “Plating” is where a metal layer (a sodium layer in the case of a sodium ion secondary cell) is formed on the anode surface; this layer of sodium metal is highly reactive with the electrolyte, causing an increasingly large solid electrolyte layer to form which results in “fade” (reduction) of the cell capacity. Plating is observed to occur when the voltage at the anode is close to zero, for example if the anode voltage in a sodium cell falls to around 0.01V it is likely that plating will occur at the anode.

The inventors have realised that the voltages experienced by the anode and cathode when the cell is charged and discharged in the cycling/use phase (that is, after the formation charge phase) may be controlled so as to reduce fading of the cell capacity through selection of the ratio of the mass of the negative electrode active material to the mass of the positive electrode active material. For example, the ratio of the mass of the negative electrode active material to the mass of the positive electrode active material, and value of the first voltage (that is, the voltage to which the cell is charged in the cycling phase), may be selected such that the minimum voltage experienced at the anode in the cycling phase is sufficiently greater than 0V such that no plating occurs at the anode—for example, they may be selected such that the minimum voltage experienced at the anode in the cycling phase is 0.01 or greater, or 0.05V or greater.

Additionally or alternatively, the ratio of the mass of the negative electrode active material to the mass of the positive electrode active material, and value of the first voltage (that is, the voltage to which the cell is charged in the cycling phase), may be selected such that the maximum voltage experienced at the cathode in the cycling phase is less than a voltage that causes damage to the cathode by overcharging the cathode (for example does not exceed 4.3V).

For the avoidance of doubt, the “mass ratio” is the ratio of the mass (eg in grams) of the negative electrode active material in the cell stack to the mass (again in grams) of the positive electrode active material in the cell stack. It is the mass ratio of the mass of negative electrode active material to the mass of positive electrode active material as initially incorporated into the cell stack during manufacture.

The second aspect may further comprise, in a cycling phase, charging the cell to the determined voltage.

In the first or second aspect the positive electrode active material may comprise a nickel-containing sodium oxide, and may contain a nickel-containing sodium layered oxide.

In the first or second aspect the negative electrode active material may comprise disordered carbon.

A method of the first or second aspect may comprise selecting the ratio of the mass of the negative electrode active material to the mass of the positive electrode active material to be greater than 0.2, or to be greater than 0.37.

A method of the first or second aspect may comprise selecting the ratio of the mass of the negative electrode active material to the mass of the positive electrode active material to be less than 1.4, or to be less than 1.2.

A method of the first or second aspect may comprise selecting the ratio of the mass of the negative electrode active material to the mass of the positive electrode active material, and value of the first voltage, such that the maximum voltage applied to the cathode in the cycling phase is less than 4.3V.

A method of the first or second aspect may comprise selecting the ratio of the mass of the negative electrode active material to the mass of the positive electrode active material, and value of the first voltage, such that the minimum voltage applied to the anode in the cycling phase is greater than 0.01V. Alternatively, the minimum voltage applied to the anode in the cycling phase may be greater than 0.02V, or greater than 0.05V.

A third aspect of the present invention provides a metal ion secondary cell obtained by a method of the first or second aspect.

A fourth aspect of the present invention provides a sodium ion secondary cell having an anode and a cathode, the anode comprising a negative electrode active material on an anode substrate, and the cathode comprising a positive electrode active material on a cathode substrate, the negative electrode active material comprising disordered carbon and the positive electrode active material comprising a nickel-containing sodium oxide; wherein the ratio of the mass of the negative electrode active material to the mass of the positive electrode active material is greater than 0.37 and is less than 1.2.

In the first, second or fourth aspect the positive electrode active material may comprise: AᵤM¹ᵥM²_{w}M³ₓM⁴_{Y}M⁵_{z}O_{2±c}, wherein A comprises either sodium or a mixed alkali metal in which sodium is the major constituent; M¹ is nickel in an oxidation state between +2 and +4; M² comprises a metal in oxidation state +4 selected from one or more of manganese, titanium and zirconium; M³ comprises a metal in oxidation state +2, selected from one or more of magnesium, calcium, copper, zinc and cobalt; M⁴ comprises a metal in oxidation state +4, selected from one or more of titanium, manganese and zirconium; M⁵ comprises a metal in oxidation state +3, selected from one or more of aluminium, iron, cobalt, molybdenum, chromium, vanadium, scandium and yttrium; U is in the range 0<U<1; V is in the range 0.25<V<1; W is in the range 0<W<0.75; X is in the range 0≤X<0.5; Y is in the range 0≤Y<0.5; Z is in the range 0≤Z<0.5; U+V+W+X+Y+Z≤3; and c≥0.0.

In a cell of the fourth aspect the negative electrode active material may comprise hard carbon.

In a cell of the fourth aspect the positive electrode active material may substantially comprise NaNi_{0.33}Mn_{0.33}Mg_{0.167}Ti_{0.167}O₂.

In a cell of the fourth aspect the ratio of the mass of the negative electrode active material to the mass of the positive electrode active material may be greater than around 0.5, and/or may be less than 0.9.

A fifth aspect of the present invention provides a method of determining parameters for a sodium ion secondary cell, the method comprising: determining, for a sodium ion secondary cell having an anode comprising a negative electrode active material on an anode substrate and a cathode comprising a positive electrode active material on a cathode substrate, a value for the mass ratio, of the mass of the negative electrode active material to the mass of the positive electrode active material, and a voltage, such that charging a cell having the determined mass ratio to the determined voltage in a cycling phase causes the minimum voltage applied to the anode in the cycling phase to be such as to prevent formation of a metal layer on the anode and causes the maximum voltage applied to the cathode in the cycling charge phase to be less than a voltage at which an irreversible loss of cathode charge capacity occurs.

A cell having the determined mass ratio may then be manufactured.

To the accomplishment of the foregoing and related ends, the invention, then, comprises the features hereinafter fully described and particularly pointed out in the claims. The foregoing description and the annexed drawings set forth in detail certain illustrative embodiments of the invention. These embodiments are indicative, however, of but a few of the various ways in which the principles of the invention may be employed. Other objects, advantages and novel features of the invention will become apparent from the foregoing detailed description of the invention when considered in conjunction with the drawings.

One aspect of the present invention aims to provide a sodium secondary cell utilising two charge storage materials, these being a disordered carbon material as part of one electrode (negative electrode) and a sodium (or mixed alkali metal containing sodium as the major constituent) metal oxide as part of the other electrode (positive electrode). The cell is built in such a way that the minimum voltage reached by the negative electrode and the maximum voltage reached by the positive electrode are controlled via selection of the mass ratio between these active materials with respect to the overlapping area of these electrodes (−/+).This is subsequently of benefit to the resulting cell characteristics. The resulting cell has properties which can include but are not limited to improved stability under repeated intercalation and deintercalation, high average voltage, low irreversible capacity during the first cycle, high capacity, high energy and increased safety characteristics.

A sixth aspect of the present invention provides a method comprising: manufacturing a sodium ion secondary cell having an anode and a cathode, the anode comprising a negative electrode active material comprising disordered carbon on an anode substrate, and the cathode comprising a comprising a nickel-containing sodium oxide positive electrode active material on a cathode substrate; and in a cycling phase, charging the cell to a first voltage; wherein the ratio of the mass of the negative electrode active material to the mass of the positive electrode active material is greater than 0.37 and is less than 1.2.

The positive electrode active material may comprises: AᵤM¹ᵥM²_{w}M³ₓM⁴_{Y}M⁵_{z}O_{2±c}, wherein A comprises either sodium or a mixed alkali metal in which sodium is the major constituent; M¹ is nickel in an oxidation state between +2 and +4; M² comprises a metal in oxidation state +4 selected from one or more of manganese, titanium and zirconium; M³ comprises a metal in oxidation state +2, selected from one or more of magnesium, calcium, copper, zinc and cobalt; M⁴ comprises a metal in oxidation state +4, selected from one or more of titanium, manganese and zirconium; M⁵ comprises a metal in oxidation state +3, selected from one or more of aluminium, iron, cobalt, molybdenum, chromium, vanadium, scandium and yttrium; U is in the range 0<U<1; V is in the range 0.25<V<1 ; W is in the range 0<W<0.75; X is in the range 0≤X<0.5; Y is in the range 0≤Y<0.5; Z is in the range 0≤Z<0.5; U+V+W+X+Y+Z≤3; and c≥0.0.

The ratio of the mass of the negative electrode active material to the mass of the positive electrode active material may be greater than 0.2.

The ratio of the mass of the negative electrode active material to the mass of the positive electrode active material may be greater than 0.37.

The ratio of the mass of the negative electrode active material to the mass of the positive electrode active material may be less than 1.4.

The ratio of the mass of the negative electrode active material to the mass of the positive electrode active material may be less than 1.2.

The ratio of the mass of the negative electrode active material to the mass of the positive electrode active material, and value of the first voltage, may be selected such that the maximum voltage applied to the cathode in the cycling phase is less than 4.3V.

The ratio of the mass of the negative electrode active material to the mass of the positive electrode active material, and value of the first voltage, may be selected such that the minimum voltage applied to the anode in the cycling phase is greater than 0.01V.

This Nonprovisional application claims priority under 35 U.S.C. § 119 on Patent Application No. 1519245.3 filed in Great Britain on Oct. 30, 2015, the entire contents of which are hereby incorporated by reference.

### INDUSTRIAL APPLICABILITY

One aspect of the invention relates to an improvement in sodium ion battery technology and may be applied for use in many different applications such as energy storage devices, rechargeable batteries and electrochemical devices. Advantageously the cells according to one aspect of the invention maximise the utilisation of the active materials in the electrodes, therefore maximising the energy density of the cells.

1. A method comprising:
manufacturing a sodium ion secondary cell having an anode and a cathode, the anode comprising a negative electrode active material comprising disordered carbon on an anode substrate, and the cathode comprising a comprising a nickel-containing sodium oxide positive electrode active material on a cathode substrate; and in a cycling phase, charging the cell to a first voltage;
wherein the ratio of the mass of the negative electrode active material to the mass of the positive electrode active material is greater than 0.37 and is less than 1.2.

2. A method as claimed in claim 1 wherein the positive electrode active material comprises: AᵤM¹ᵥM²_{w}M³ₓM⁴_{Y}M⁵_{z}O_{2±c}, wherein
A comprises either sodium or a mixed alkali metal in which sodium is the major constituent;
M¹ is nickel in an oxidation state between +2 and +4;
M² comprises a metal in oxidation state +4 selected from one or more of manganese, titanium and zirconium;
M³ comprises a metal in oxidation state +2, selected from one or more of magnesium, calcium, copper, zinc and cobalt;
M⁴ comprises a metal in oxidation state +4, selected from one or more of titanium, manganese and zirconium;
M⁵ comprises a metal in oxidation state +3, selected from one or more of aluminium, iron, cobalt, molybdenum, chromium, vanadium, scandium and yttrium;
U is in the range 0<U<1
V is in the range 0.25<V<1 ; W is in the range 0<W<0.75; X is in the range 0≤X<0.5;
Y is in the range 0≤Y<0.5; Z is in the range 0≤Z<0.5;
U+V+W+X+Y+Z≤3; and
c≥0.0.

3. A method as claimed in claim 1 and comprising selecting the ratio of the mass of the negative electrode active material to the mass of the positive electrode active material to be greater than 0.2.

4. A method as claimed in claim 1 and comprising selecting the ratio of the mass of the negative electrode active material to the mass of the positive electrode active material to be greater than 0.37.

5. A method as claimed in claim 1 and comprising selecting the ratio of the mass of the negative electrode active material to the mass of the positive electrode active material to be less than 1.4.

6. A method as claimed in claim 1 and comprising selecting the ratio of the mass of the negative electrode active material to the mass of the positive electrode active material to be less than 1.2.

7. A method as claimed in claim 1 and comprising selecting the ratio of the mass of the negative electrode active material to the mass of the positive electrode active material, and value of the first voltage, such that the maximum voltage applied to the cathode in the cycling phase is less than 4.3V.

8. A method as claimed in claim 1 and comprising selecting the ratio of the mass of the negative electrode active material to the mass of the positive electrode active material, and value of the first voltage, such that the minimum voltage applied to the anode in the cycling phase is greater than 0.01V.
